(19) United States
(12) Patent Application Publication
(10) Pub. No.: US 2006/0096435 A1
(43) Pub. Date: May 11, 2006

(54) Apparatus to simultaneously cut apertures and perimeter contours in a sheet-type work material

(76) Inventors: Darryl C. Stein, Andover, CT (US); M. Shawn Cole, Tolland, CT (US)

Correspondence Address: MORGAN & FINNEGAN, L.L.P., 3 World Financial Center, New York, NY, 10281-2101, US

(21) Appl. No.: 11/317,351

(22) Filed: Dec. 23, 2005

Related U.S. Application Data
(63) Continuation-in-part of application No. 10/627,003, filed on Jul. 25, 2003, now Pat. No. 7,011,007.
(60) Provisional application No. 60/398,936, filed on Jul. 26, 2002.

(51) Int. Cl. B26D 1/00

(52) U.S. Cl. 83/651

(57) ABSTRACT

An apparatus is disclosed having a notching tool and a cutter that work together to cut perimeter contours and notch geometry along the perimeter of a work material with high precision and quality in a single pass of the cutting mechanism. The apparatus includes a rotary die that is rotatably coupled to a cutting head for movement between a working position where the cutter engages the work material and a non-working position where the cutter is positioned away from the work material. The cutter is positioned relative to a shaped die blade when both the cutter and die blade are in the working position to allow pattern pieces to be simultaneously cut and notched in response to commands issued from a controller. The apparatus is faster than conventional mechanisms used for cutting notches along work material piece perimeters since the notching and cutting operations are done in parallel.

### RELATED APPLICATION

This application is a continuation-in-part of U.S. patent application Ser. No. 10/627,003, filed Jul. 25, 2003, the disclosure of which is hereby incorporated by reference.

### FIELD OF INVENTION

The present invention is generally directed to cutting and creating apertures such as notches in sheet-type work material and is more specifically directed to simultaneously cutting an edge and generating notches and other shaped apertures.

### BACKGROUND OF THE INVENTION

Pattern pieces cut from layers of sheet-type work material particularly those cut from leather hides often have apertures such as holes or notches cut therein. In many instances, these notches are cut into arcuate edges of the pattern piece. Historically, cutting these notched pattern pieces involved a two step process. Generally, the notches are first cut into the work material with a punch or a cutting blade, and then the edges of the pattern piece are cut typically using a wheel type cutter. Cutting the notches, particularly if there are many, is in and of itself a labor intensive, time consuming process. Following the notching step with the subsequent step of cutting the peripheral edges further increases the time required to cut the pattern piece from the work material.

Another difficulty occurs when a series of different notch patterns or differently shaped notches are required in the same pattern piece. When this occurs it is necessary to have on hand and use several different notch cutting tools as well as to properly layout the notch pattern. These steps can greatly and detrimentally affect the amount of time it takes to cut a pattern piece from the work material. In addition, because of the requirement for multiple operations, the likelihood for errors to be made increases.

Based on the foregoing, it is the general object of the present invention to provide a notching and cutting apparatus that improves upon or overcomes the drawbacks of prior art devices.

### SUMMARY OF THE INVENTION

The present invention is directed in one aspect to an apparatus for cutting pattern pieces in, and creating apertures in sheet-type work material wherein the apparatus includes a frame having a support surface mounted thereon for carrying at least one layer of the work material. A carriage is coupled to the frame for movement back-and-forth there along in a first coordinate direction in response to commands issued from a controller. A cutting head is mounted to the carriage for movement back-and-forth along the carriage in a second coordinate direction generally perpendicular to the first coordinate direction. A rotary die is rotatably coupled to the cutting head with at least one cutting tool coupled thereto. The cutting tool has a shaped cutting portion corresponding to the shape of an aperture to be formed in the work material. As used herein, the term “aperture” should be broadly construed to include both holes and edge notches. The rotary die is movable between a working position wherein the at least one cutting tool engages the work material and a non-working position wherein the rotary die is positioned away from the work material. During operation when the rotary die is in the working position, shaped apertures are formed in the work material.

Preferably, a cutter is coupled to the cutting head for movement between a working position wherein the cutter engages the work material and a non-working position wherein the rotary die and the cutter are positioned away from the work material. In the preferred embodiment, the cutter is positioned adjacent to the rotary die when in the working position to allow pattern pieces to be simultaneously cut and notched in response to commands issued from the controller.

In the preferred embodiment of the present invention, the rotary die is coupled to an actuator that is positioned between the rotary die and the cutting head. The actuator is of a suitable type, such as, but not limited to a servo or stepper motor. The actuator selectively indexes the rotary die to position a cutting tool mounted thereon, in proximity to the work material. In addition, causing the die to roll along the work material will allow for patterns of spaced-apart apertures to be cut.

In one embodiment of the present invention, the rotary die is adapted to carry a plurality of cutting tools. In addition, each of the cutting tools can be pivotally coupled to the rotary die to allow a cutting portion defined by the die to rotate into or out of position as the rotary die is indexed. The cutting tools can be configured so that each cuts the same shaped aperture or different shaped apertures or a combination thereof. A tool changer can also be provided so that during operation different cutting tools can be loaded onto or removed from the rotary die.

In another embodiment of the invention, the cutting head comprises an outer housing and an inner housing. A first drive means, rigidly attached to the outer housing, is rotatably coupled to the inner housing, allowing the inner housing to rotate without restriction through 360° while the first drive means and outer housing remain stationary and rigidly attached to the carriage. Specifically, the rotary die and cutter are rotatably coupled to the inner housing and can be moved to an origin position on the work material by controllably rotating the inner housing using a horizontal drive means. Alternatively, a rotary fitting rigidly attached to the cutting head can also be used to provide unrestricted rotation of the rotary die and the cutter through 360°. Detection of an origin position on the work material can be accomplished using a one-to-one ratio between the horizontal drive means and the inner housing or using, in conjunction with the horizontal drive means, a sensor providing an index pulse that corresponds to the origin position. Similarly, moving the cutting tool to an origin position on the work material may be accomplished using a one-to-one ratio between the first drive means and the rotary die or using, in conjunction with the first drive means, a sensor providing an index pulse that corresponds to the origin positions.

In another form of the present invention, a shaped die blade is coupled to the cutting head and has a shaped cutting portion corresponding to the shape of an aperture to be formed in the work material. The shaped die blade is movable between a working position wherein the shaped die blade engages the work material and a non-working position wherein the shaped die blade is positioned away from the work material. The movement of the shaped die blade between working and non-working positions is linear. In addition, the cutter is positioned in precise alignment with the shaped die blade when each is in working position, thereby allowing pattern pieces to be simultaneously cut and notched in response to commands issued from the controller.

An advantage of the present invention is that the process of cutting apertures into the work material in predetermined patterns can be performed quickly and automatically.

Another advantage of the present invention is that a pattern piece can be simultaneously notched and the edges cut.

These aspects and other objects, features and advantages of the invention are described in the following Detailed Description, which is to be read in conjunction with the accompanying drawings.

### BRIEF DESCRIPTION OF THE DRAWINGS

FIG. 1 is a partial schematic illustration of a cutting table incorporating the present invention.

FIG. 2 schematically illustrates a rotary die coupled to a cutting head forming part of the cutting table of FIG. 1.

FIG. 3 is a front elevational view of an embodiment of a rotary die without a cutting tool mounted thereon.

FIG. 4 is a side elevational view of the rotary die of FIG. 3.

FIG. 5 is a perspective view of an embodiment of one type of cutting tool mountable on the rotary die of FIG. 3.

FIG. 6 is a partial schematic illustration of a multiple cutting tool attached to the rotary die.

FIG. 7 schematically illustrates a rotary die, an edge cutting tool and a tool changer.

FIG. 8 schematically illustrates a rotary die and an edge cutting tool.

FIG. 9 schematically illustrates a rotary die and an edge cutting tool coupled to a cutting head forming part of the cutting table of FIG. 1.

FIG. 10 is a front view of an embodiment of the invention that includes a rotary die.

FIG. 11 is a cross-sectional view of the embodiment of FIG. 10 taken along line 1-1 of FIG. 10.

FIG. 12 is a cross-sectional view illustrating a cutting head with a first drive means rigidly attached to an outer housing and rotatably coupled with an inner housing.

FIG. 13 is an alternative embodiment to FIG. 12, illustrating a rotary fitting rigidly attached to the cutting head.

FIG. 14 is a cross-sectional view of the wheel knife assembly as shown in FIG. 13.

FIG. 15 is a front view of an embodiment of the invention that includes a shaped die blade.

### DETAILED DESCRIPTION OF THE PREFERRED EMBODIMENTS

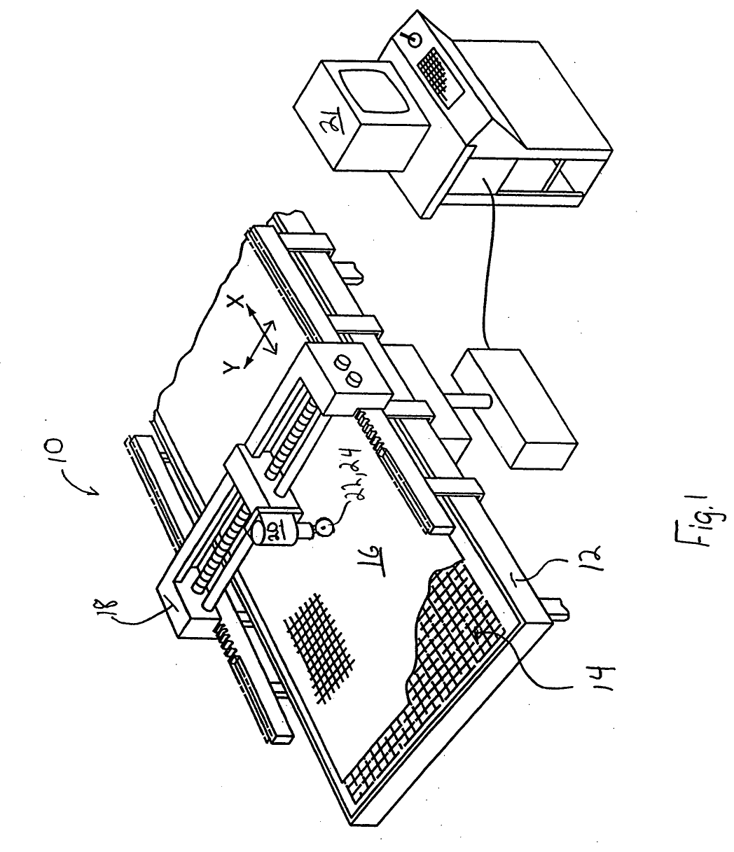

As shown in FIG. 1, a cutting table generally designated by the reference number 10, includes a frame 12 and work material support surface 14 adapted to carry at least one layer of sheet-type work material 16, such as, but not limited to leather or vinyl thereon. A carriage 18 is coupled to the frame for movement back-and-forth in a first direction as indicated by the arrows labeled “X.” A cutting head 20 is mounted on the carriage 18 and is movable back-and-forth therealong in a second direction as indicated by the arrows labeled “Y.” Both the carriage 18 and the cutting head 20 move in response to commands issued from a controller 21. As will be explained in detail below, a pair of cutting tools, each for performing a different type of cutting operation, are mounted to the cutting head 20. The cutting tools are movable between a working position, wherein they engage the work material 16, and a non-working position wherein they are lifted off of the work material.

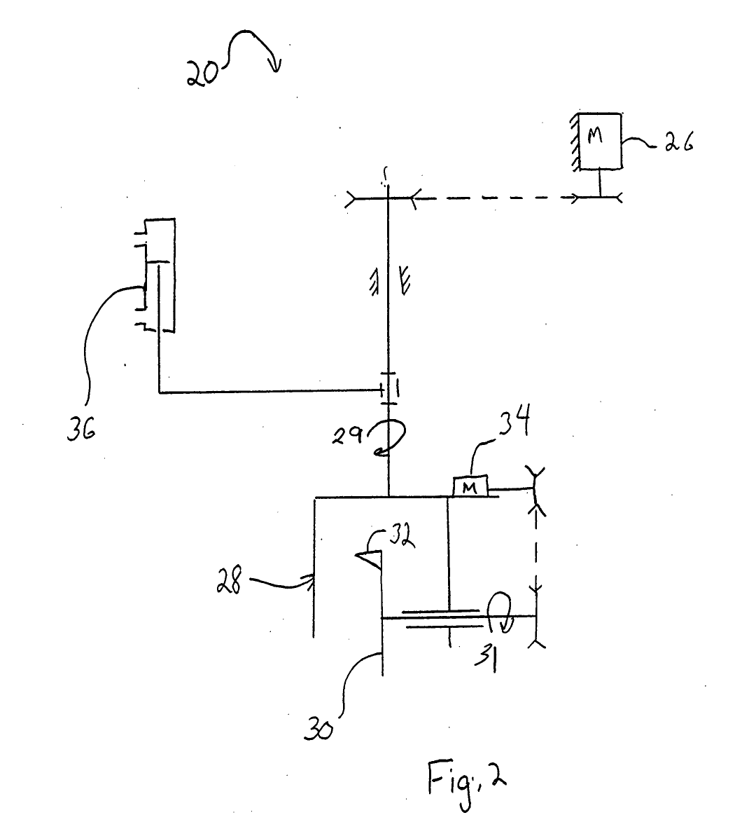

As shown schematically in FIG. 2, the cutting head 20 includes a suitable drive, such as motor 26 coupled to a housing 28. The motor 26 may be a servo motor, stepper motor or the like. The housing 28 is rotatable about an axis designated by the reference number 29 by the stepper motor 26. The axis 29 is generally perpendicular to the axis 31 about which the rotary die 30 rotates. A rotary die 30 having at least one cutting tool 32 mounted thereon is rotatably coupled to the housing 28 and is driven by suitable means, such as, but not limited to a second stepper motor 34. An actuator 36 shown in the illustrated embodiment as a pneumatic cylinder is mounted to the cutting head 20 and coupled to the housing 28 to move the housing between the working and non-working positions. While first and second servo motors or stepper motors, 26 and 34 respectively, have been shown and described, the present invention is not limited in this regard as other types of actuators known to those skilled in the pertinent art to which the present invention pertains, such as servos, can be substituted without departing from the broader aspects of the invention. The same is true for the pneumatic cylinder, other types of actuators such as stepper motors, servos, or hydraulic cylinders can be substituted.

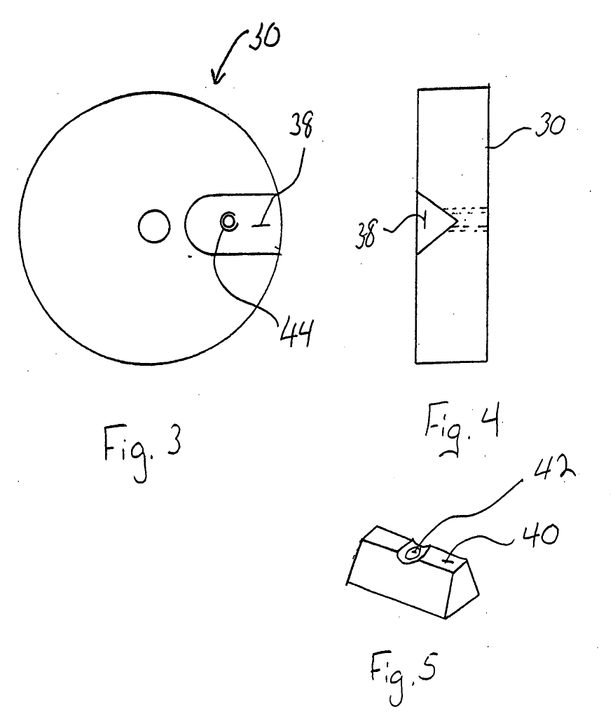

As shown in FIGS. 3-5, the rotary die 30 includes a recessed section 38 into which a cutting tool 40 is mounted. The cutting tool 40 defines an aperture 42 extending therethrough. A fastener not shown extends through the aperture 42 and threadably engages a tapped hole 44 defined by the rotary die 30. While a fastener extending through the aperture 42 and engaging the tapped hole 44 has been described, the present invention is not limited in this regard as other mounting means, such as a taper lock, ball and detent, or snap fit can be employed without departing from the broader aspects of the present invention. In addition, while a cutting tool 40 has been shown and described, the present invention is not limited in this regard as other types of tools such as a punch can be substituted without departing from the broader aspects of the present invention.

During operation, and in response to command signals issued from the controller 21, the rotary die 30 is moved to a position where a notch or aperture is to be cut, the rotary die is indexed to position the cutting tool 32 over the work material 16. The cutting tool 32 is then brought into engagement with the work material 16 and a notch or other shaped aperture is cut.

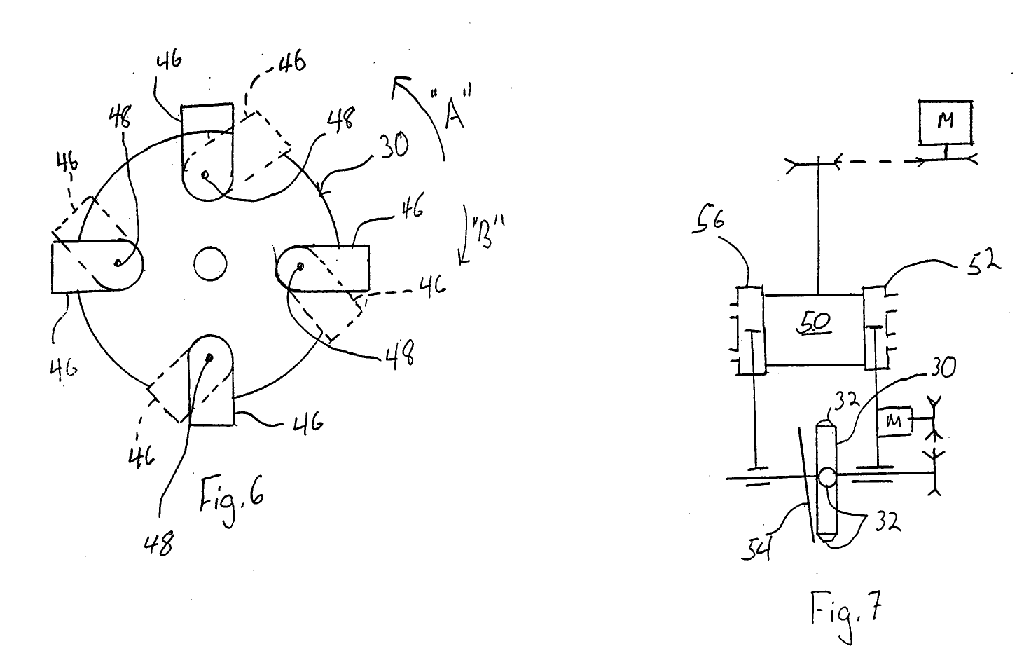

As shown in FIG. 6, the rotary die 30 can be configured to accommodate multiple cutting tools 32. In the illustrated embodiment four tool holders 46 are mounted for pivotal movement about a pivot axis 48. The tool holders 46 move to the rotated position (shown in dotted lines) when the rotary die 30 is rotated in the direction indicated by the arrow labeled “A.” When the rotary die 30 is rotated in the direction labeled “B”, generally opposite the “A” direction, the tool holder 46 closest to the work material moves into cutting position so that a cutting tool mounted thereon can be employed. While the directions “A” and “B” are shown in the illustrated embodiment as counter-clockwise and clockwise respectively, the present invention is not limited in this regard as the tool holders 46 can be configured to function opposite to the above-described manner.

As shown schematically in FIG. 7, the present invention can also incorporate a tool changer 50 for storing several different cutting tools. During operation, when a different, or new cutting tool is required, the actuator 52 moves the rotary die 30 to the tool changer 50 where a mounted cutting tool is removed and stored, and a new or different cutting tool is installed. Also shown in FIG. 7 is a cutter 54 for cutting along pattern edges. In general the cutter 54 is round having a sharpened edge and is rotatable about an axis 55 that is generally coaxial with the axis 31 about which the rotary die 30 is rotatable. Both the rotary die and the cutter wheel are mountable via rotation of the housing 28, by the stepper motor 26, about the axis 29. During operation the cutter 54, in response to commands issued from the controller 21 engages the work material and is dragged via the movement of the carriage 18 and cutting head 20 along a cutting path. The actuator 56 moves the cutter 54 between the working and non-working positions.

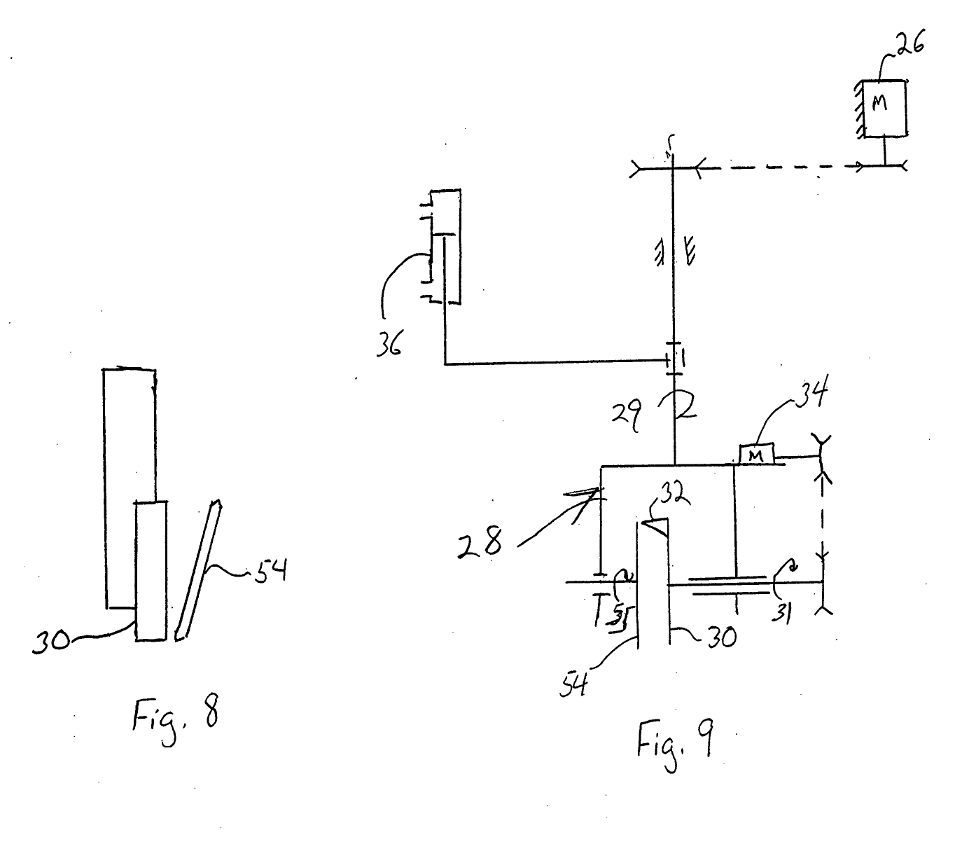

As shown schematically in FIGS. 8 and 9, the cutter 54 is positioned proximate the rotary die 30 so that during operation a continuous cut along a desired line of cut can be made while simultaneously cutting notches or other shaped apertures in the work material. This has the advantage of increasing throughput over prior art machines wherein notching and cutting are usually done as separate operations.

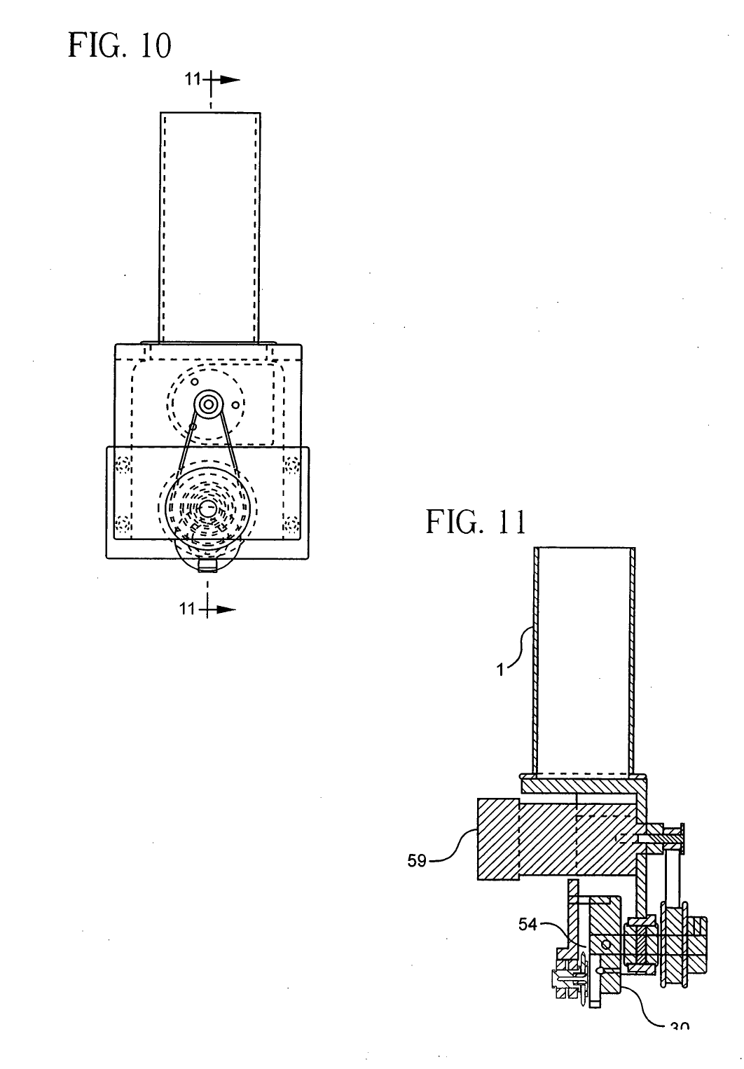

FIGS. 10 and 11 show an embodiment of the present invention that includes a rotary die 30 and cutter 54, whereby a motor 59 provides for the rotation of the rotary die 30. The motor 59 may be a servo motor, DC motor or the like.

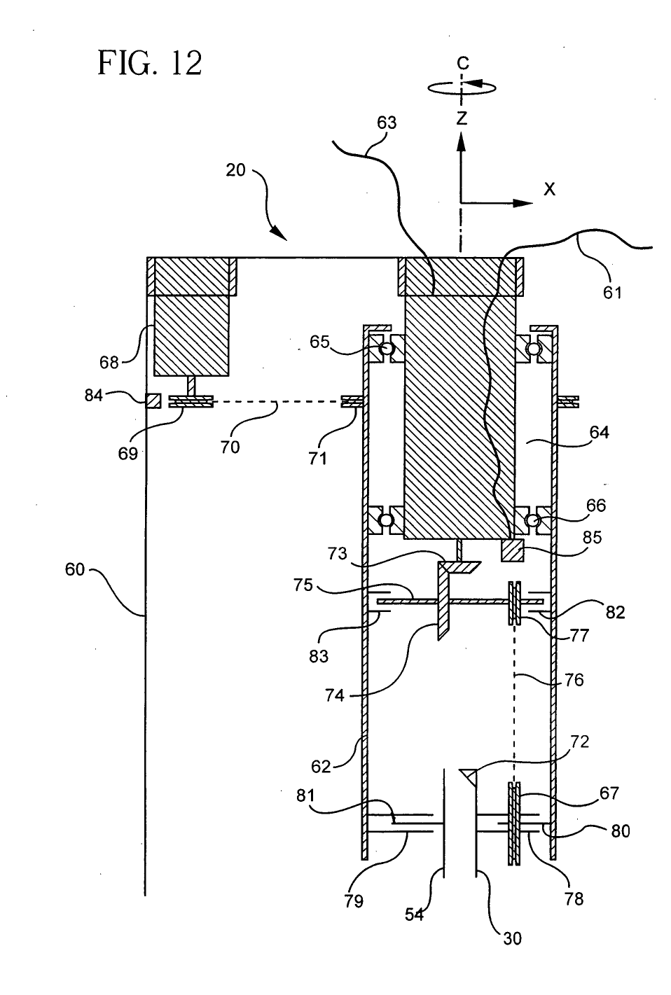

In accordance with another aspect of the invention, FIG. 12 shows an embodiment whereby the cutting head 20 is comprised of an outer housing 60 and inner housing 62. A first drive means 64 is rigidly attached to the top of the outer housing 60 and positioned vertically such that at least a portion of the first drive means 64 is contained inside the outer housing 60. The inner housing 62 is rotatably coupled to the first drive means 64 by a first rotational coupling 65 and a second rotational coupling 66. As a result, the inner housing 62 is able to rotate through 360° about a rotational axis labeled “C” so as not to be restricted by sensor output wire 61 and motor power and feedback wires 63. A horizontal drive means 68 rigidly attached to the outer housing 60, and in conjunction with a first timing pulley 69, first timing belt 70 and second timing pulley 71, controls the rotation of the inner housing 62 about the first drive means 64.

FIG. 12 also shows the rotary die 30 and cutter 54 rotatably coupled to the inner housing 62 by a third rotational coupling 78 and fourth rotational coupling 79, respectively. The rotary die 30 is rotatable about a first rotational axis 80 generally perpendicular to the rotational C-axis about which the inner housing 62 rotates. The cutter 54 rotates about a second rotational axis 81 approximately coaxial with the first rotational axis 80. The rotary die 30 has at least one cutting tool 72 mounted thereon and is driven by the first drive means 64, in conjunction with first bevel gear 73, second bevel gear 74, axle 75, third timing pulley 67, second timing belt 76 and fourth timing pulley 77. The axle 75 is coupled to the inner housing 62 by a fifth rotational coupling 82 and sixth rotational coupling 83. While a servomotor is shown in FIG. 12, the present invention is not limited in this regard as other types of drive means known to those skilled in the pertinent art to which the present invention pertains, such as servos, can be substituted without departing from the broader aspects of the invention.

Moreover, the embodiment in FIG. 12 provides for the rotary die 30 and cutter 54 to be moved to origin positions on the work material prior to the start of, or during, operation. Specifically, controlled rotation of the inner housing 62 by the horizontal drive means 68 in response to command signals from the controller 21 allows for the rotary die 30 and cutter 54 to be precisely aligned tangent to an edge of the work material. Detection of such origin position on the work material can be accomplished using a one-to-one ratio between the first timing pulley 69 and the second timing pulley 71 and employing a horizontal drive means 68 with positional feedback that includes an index pulse. In particular, a one-to-one ratio, whereby one turn of the horizontal drive means 68 equals one turn of the inner housing 62, will generate one index pulse for each revolution of the inner housing 62, wherein the index pulse corresponds to an origin position. If the ratio is not one-to-one, a sensor 84 can be used to indicate which index pulse corresponds to the origin position. For example, if the ratio is four to one, whereby four turns of the horizontal drive means 68 equal one turn of the inner housing 62, then four index pulses are generated for each revolution of the inner housing 62. With such a ratio an ambiguity results as to which index pulse corresponds to an origin position. The sensor 84 provides additional feedback telling the index pulse in a sequence that corresponds to an origin position. The sensor 84 may register a reflective portion of the first timing belt 70 that overlaps the correct index pulse. The sensor 84 may also be a switch that registers a raised surface or detent on a portion of the first timing belt 70 that overlaps the correct index pulse. Similarly, the cutting tool 72 can be moved to an origin position on the work material using a one-to-one ratio or employing a sensor 85 as detailed above.

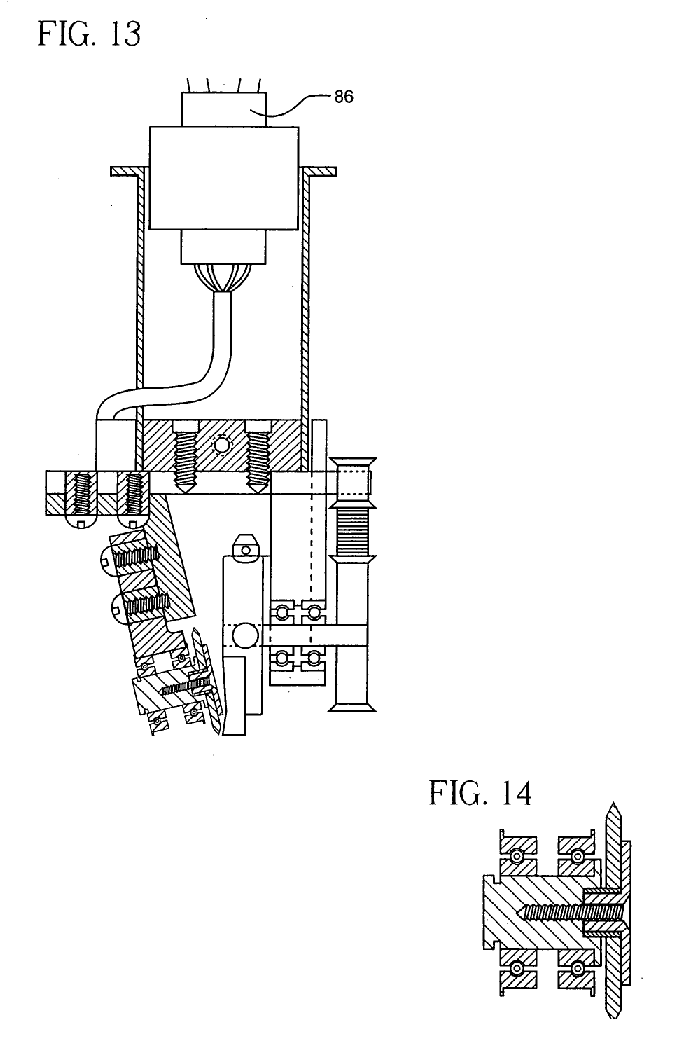

Cross-sectional view FIG. 13 shows an alternative embodiment to FIG. 12, whereby a rotary interconnect 86 provides for the rotation of the housing 28 about the rotational C-axis of through 360° so as not to be restricted by wires 87. Also shown in FIG. 13 is a cutter assembly, which is shown in more detail in FIG. 14.

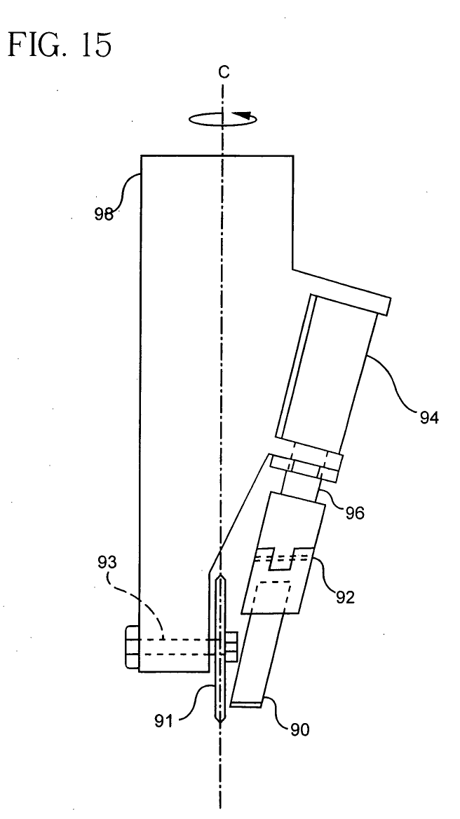

As shown in FIG. 15, the present invention can also be configured with a shaped die blade 90 that cuts apertures in the work material through linear movement. The shaped die blade 90 is coupled to a blade holder 92, which may be hinged in such a fashion as to allow controlled deflection of the tool during continuous motion around the perimeter contour to achieve minimal disturbances of the work material. The blade holder 92 is attached to a linear actuation device 94 via a connecting shaft 96. The linear actuation device 94 is mounted to a tool holder 98 and moves the shape die blade 90 between a working position wherein the shaped die blade 90 engages the work material and a non-working position wherein the shaped die blade 90 is positioned away from the work material. It has been found that a linear motor, servo motor and cam or pneumatic cylinder with a piston function particularly well as linear actuation devices. It will appreciated, however, that other drive mechanisms providing for linear extension may also perform sufficiently and achieve the objectives of the invention. During operation, the linear actuation device 94 is actuated in a controlled manner at the required and moves the shaped die blade 90 into working proximity of the work material through linear extension of the connecting shaft 96 and blade holder 92. After an aperture is cut, the linear actuation device returns the shaped die blade 90, via the blade holder 92 and connecting shaft 96 to its retracted position until the next command.

Also shown in FIG. 15 is a cutter 91, which is round having a sharpened edge and rotatable about an axis 93. The cutter 91 and shaped die blade 90 are fixed in position relative to each other so as to share a common rotational C-axis and also provide simultaneous aperture cutting and perimeter contour cutting. The tool holder 98 can be raised and lowered in the Z-axis as required and can also be rotated around the rotational C-axis as required. Cutting of external apertures with this embodiment would require a reversed direction of perimeter cutting and that the cutter 91 be momentarily removed from working proximity of the work material at the controlled time with a Z-axis movement in order to create a break in the perimeter contour.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. An apparatus for cutting pattern pieces and creating apertures in sheet-type work material, comprising:
a frame;
a support surface mounted on said frame for carrying at least one layer of sheet-type work material thereon;
a carriage coupled to said frame for movement back-and-forth there along in a first coordinate direction in response to commands issued from a controller;
a cutting head mounted to said carriage for movement back-and-forth there along in a second coordinate direction generally perpendicular to said first coordinate direction in response to commands issued from said controller;
a rotary die rotatably coupled to said cutting head;
at least one cutting tool coupled to said rotary die, said cutting tool having a shaped cutting portion corresponding to the shape of an aperture to be formed in said work material;
said rotary die being movable between a working position wherein said at least one cutting tool engages said work material, and a non-working position wherein said rotary die is positioned away from said work material; and
said cutting head further including an outer housing and an inner housing, said outer housing having a first drive means rigidly attached to said outer housing, said inner housing contained within said outer housing and rotatably coupled to said first drive means to allow said inner housing to rotate about 360° without restriction independent of said first drive means and said outer housing.

2. An apparatus as defined by claim 1, wherein said rotary die and said cutter are rotatably coupled to said inner housing.

3. An apparatus as defined by claim 2, wherein said rotary die rolls about a first rotational axis and said cutter rotates about a second rotational axis approximately coaxial with said first rotational axis, wherein said rotary die and said cutter can be moved between an origin position and a non-origin position on said work material by rotating said inner housing about a third rotational axis approximately perpendicular to said first rotational axis.

4. An apparatus as defined by claim 3, wherein a one-to-one gear ratio between said first drive means and said rotary die is used to detect an origin position on said work material.

5. An apparatus as defined by claim 3, further including a sensor for providing an index pulse corresponding to said origin position used in conjunction with said first drive means to detect an origin position on said work material.

6. An apparatus as defined by claim 3, further comprising a horizontal drive means for controllably rotating said inner housing about said third rotational axis in response to commands issued from said controller.

7. An apparatus as defined by claim 6, wherein a one-to-one ratio between a timing pulley of said horizontal drive means and a timing pulley of said inner housing is used to detect an origin position said on said work material.

8. An apparatus as defined by claim 6, wherein a sensor providing an index pulse corresponding to said origin position is used in conjunction with said horizontal drive means to detect an origin position on said work material.

9. An apparatus as defined by claim 1, further comprising a rotary fitting rigidly attached to said cutting head and providing rotary die and said cutter with unrestricted freedom to rotate about 360°.

10. An apparatus for cutting pattern pieces and creating apertures in sheet-type work material, comprising:
a frame;
a support surface mounted on said frame for carrying at least one layer of sheet-type work material thereon;
a carriage coupled to said frame for movement back-and-forth there along in a first coordinate direction in response to commands issued from a controller;
a cutting head mounted to said carriage for movement back-and-forth there along in a second coordinate direction generally perpendicular to said first coordinate direction in response to commands issued from said controller;
a shaped die blade coupled to said cutting head and having a shaped cutting portion corresponding to the shape of an aperture to be formed in said work material; and
said shaped die blade being movable between a working position wherein said shaped die blade engages said work material and a non-working position wherein said shaped die blade is positioned away from said work material, wherein the movement of said shaped die blade between said working and said non-working positions is linear.

11. An apparatus as defined by claim 10, further comprising a linear actuation device for moving said shaped die blade between said working and said non-working positions.

12. An apparatus as defined by claim 11, wherein said linear actuation device is a linear motor.

13. An apparatus as defined by claim 11, wherein said linear actuation device comprises a servo motor and cam.

14. An apparatus as defined by claim 11, wherein said linear actuation device comprises a pneumatic cylinder with piston.

15. An apparatus as defined by claim 10, further comprising a cutter coupled to said cutting head for movement between a working position wherein said cutter engages said work material and a non-working position wherein said cutter is positioned away from said work material, and wherein said cutter is positioned relative to said shaped die blade when each is in said working position, thereby allowing pattern pieces to be simultaneously cut and notched in response to commands issued from said controller.

16. An apparatus as defined by claim 15, further comprising at least one drive means for moving said cutter between said working position and said non-working position.

17. An apparatus as defined by claim 15, wherein said shaped die blade moves along a first linear axis and said cutter rotates about a first rotational axis, wherein said shaped die blade and said cutter can be positioned simultaneously by rotation about a second rotational axis approximately perpendicular to said first rotational axis.

18. An apparatus as defined in claim 15, wherein said cutter is a rotary die that defines a sharpened peripheral edge, said rotary die rotatably coupled to said cutting head.

19. An apparatus for cutting pattern pieces and creating apertures in sheet-type work material, comprising:
a frame;
a support surface mounted on said frame for carrying at least one layer of sheet-type work material thereon;
a carriage coupled to said frame for movement back-and-forth there along in a first coordinate direction in response to commands issued from a controller;
a cutting head mounted to said carriage for movement back-and-forth there along in a second coordinate direction generally perpendicular to said first coordinate direction in response to commands issued from said controller;
a shaped die blade coupled to said cutting head and having a shaped cutting portion corresponding to the shape of an aperture to be formed in said work material;
said shaped die blade being movable between a working position wherein said shaped die blade engages said work material and a non-working position wherein said shaped die blade is positioned away from said work material, wherein the movement of said shaped die blade between said working and said non-working positions is linear;
a rotary die that defines a sharpened peripheral edge, said rotary die rotatably coupled to said cutting head for movement between a working position wherein said cutter engages said work material and a non-working position wherein said cutter is positioned away from said work material, and wherein said cutter is positioned relative to said shaped die blade when each is in said working position, thereby allowing pattern pieces to be simultaneously cut and notched in response to commands issued from said controller.

20. An apparatus as defined by claim 19, wherein said shaped die blade moves along a first linear axis and said cutter rotates about a first rotational axis, wherein said shaped die blade and said cutter can be positioned simultaneously by rotation about a second rotational axis approximately perpendicular to said first rotational axis.
